(19) United States
(12) Patent Application Publication
(10) Pub. No.: US 2016/0203009 A1
(43) Pub. Date: Jul. 14, 2016

(54) METHODS FOR EMULATING COMPUTING DEVICES AND DEVICES THEREOF

(71) Applicant: Modea Holdings, Inc., Blacksburg, VA (US)

(72) Inventors: David G. Catalano, Blacksburg, VA (US); Thomas Edward Robinson, Roanoke, VA (US); Charles Wall, Durham, NC (US); Alex B. Miller, Durham, NC (US)

(21) Appl. No.: 14/594,218

(22) Filed: Jan. 12, 2015

(51) Int. Cl. G06F 9/455

(52) U.S. Cl. CPC G06F 9/455

(57) ABSTRACT

A method, non-transitory computer readable medium and emulation manager computing device for obtaining a stored emulation of a selected one of a plurality of type of mobile computing devices embedded with a one of a plurality of software versions. Availability of an updated version of the embedded one of the plurality of software versions for the stored version is determined. An updated emulation is generated where the updated emulation includes the selected one of the plurality of types of mobile computing devices embedded with the updated version of the embedded one of the plurality of software versions. The generated updated emulation is provided to the requesting user computing device without requiring the requesting client computing device to download or install additional software.

### FIELD

This technology relates to software emulation and, more particularly, to methods for emulating computing devices and devices thereof.

### BACKGROUND

Currently, users are faced with large number and variety of different types of computing devices such as, smartphones, electronic book readers, tablet computers, and video game consoles by way of example. Additionally, even within a particular category or even brand of computing device, there are a multitude of different versions. As a result, when making a buying decision, users often are unsure of even which subset of computing devices to consider for purchase. Further, to try these devices or download and try additional software, users often must actually possess the device.

To address this problem, simulation software has been developed to allow users to test out software on different computing devices. Unfortunately, currently this requires a download of simulation software to a device which often can be time consuming and difficult for the user to properly install and utilize. As a result, the simulation software often fails to provide users with the necessary feedback to make an educated purchasing decision leading to disappointed customers and/or lost sales.

### SUMMARY

A method for emulating a mobile computing device includes an emulation manager computing device for obtaining a stored emulation of a selected one of a plurality of type of mobile computing devices embedded with a one of a plurality of software versions. Availability of an updated version of the embedded one of the plurality of software versions for the stored version is determined by the emulation manager computing device. An updated emulation is generated by the emulation manager computing device where the updated emulation includes the selected one of the plurality of types of mobile computing devices embedded with the updated version of the embedded one of the plurality of software versions. The generated updated emulation is provided by the emulation manager computing device to the requesting user computing device without requiring the requesting user computing device to download or install additional software.

A non-transitory computer readable medium having stored thereon instructions for emulating a mobile computing device comprising machine executable code which when executed by at least one processor, causes the processor to perform steps including obtaining a stored emulation of a selected one of a plurality of type of mobile computing devices embedded with a one of a plurality of software versions. Availability of an updated version of the embedded one of the plurality of software versions for the stored version is determined. An updated emulation is generated where the updated emulation includes the selected one of the plurality of types of mobile computing devices embedded with the updated version of the embedded one of the plurality of software versions. The generated updated emulation is provided to the requesting user computing device without requiring the requesting client computing device to download or install additional software.

An emulation manager computing device comprising a memory coupled to one or more processors which are configured to execute programmed instructions stored in the memory includes obtaining a stored emulation of a selected one of a plurality of type of mobile computing devices embedded with a one of a plurality of software versions. Availability of an updated version of the embedded one of the plurality of software versions for the stored version is determined. An updated emulation is generated where the updated emulation includes the selected one of the plurality of types of mobile computing devices embedded with the updated version of the embedded one of the plurality of software versions. The generated updated emulation is provided to the requesting user computing device without requiring the requesting client computing device to download or install additional software.

This technology provides a number of advantages including providing methods, devices, and non-transitory computer readable medium for more effectively emulating a computing device. With this technology, users can easily test devices via one or more provided emulations. Additionally with this technology users are not required to actually possess a device to use and test a device and do not need to download and install any additional simulation. Further, this technology enables a user to save and later return to prior emulation which further enhances the experience for the user. Furthermore, this technology uses techniques illustrated below to effectively generate emulation of computing device using minimum number of processing cycles thereby increasing the CPU performance of the emulation management computing device.

### BRIEF DESCRIPTION OF THE DRAWINGS

FIG. 1 is an example of a network environment with an emulation manager computing device that emulates mobile computing devices;

FIG. 2 is an functional block diagram of the example of the emulation manager computing device shown in FIG. 1;

FIG. 3 is a flowchart of an example of a method for emulating mobile computing devices; and

FIG. 4 is a flowchart of an example of a flowchart for a method for using a stored emulation of the mobile computing devices.

### DETAILED DESCRIPTION

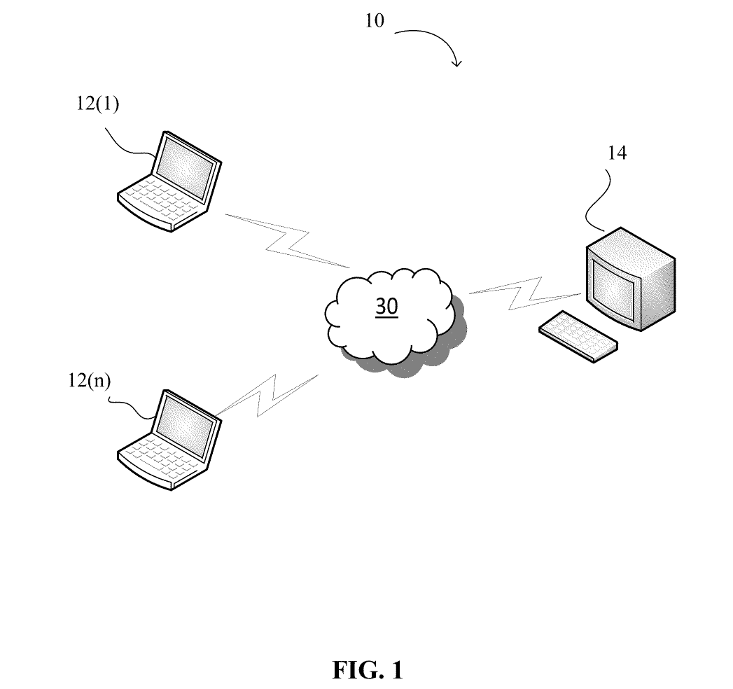

An example of a network environment 10 with an emulation manager computing device 14 that emulates one or more mobile computing devices is illustrated in FIG. 1. In this particular example, environment 10 includes a plurality of user computing devices 12(1)-12(n) and the emulation manager computing device 14 which are coupled together by the communication network 30, although the environment can include other types and numbers of devices, components, elements and communication networks in a variety of other topologies and deployments. While not shown, the exemplary environment 10 may include additional components, such as routers, switches and other devices which are well known to those of ordinary skill in the art and thus will not be described here. As described and illustrate herein, this technology provides a number of advantages including providing methods, non-transitory computer readable medium and devices for more effectively emulating mobile computing devices.

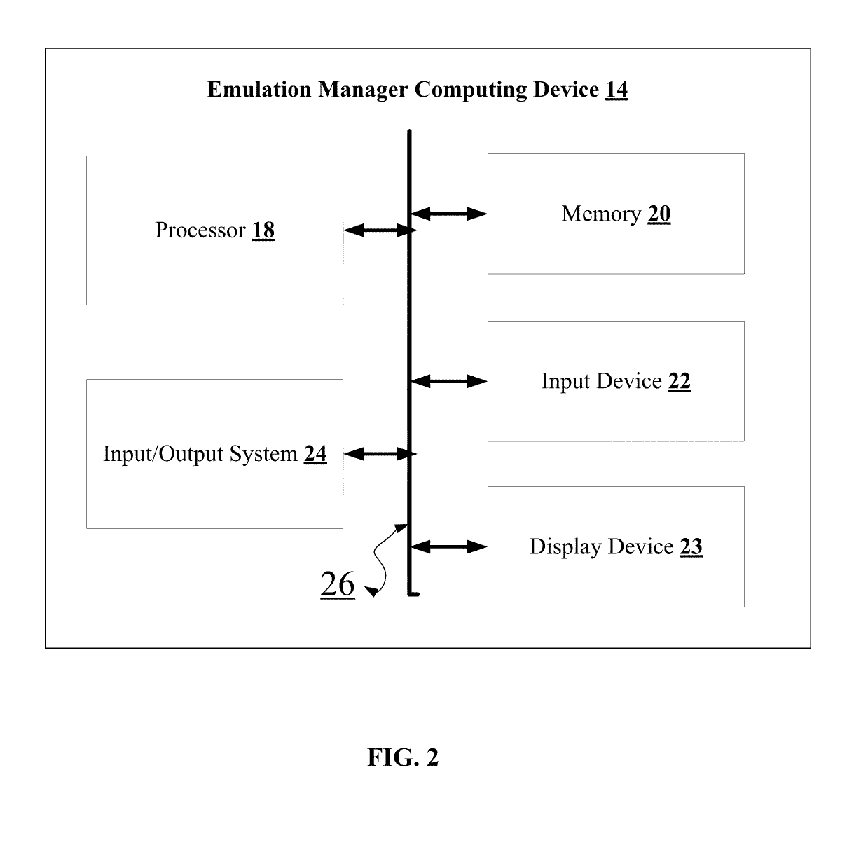

Referring more specifically to FIGS. 1-2, in this particular example the emulation manager computing device 14 interacts with the plurality of user computing devices 12(1)-12(n) through the communication network 30, although the emulation manager computing device 14 can interact with the plurality of user computing devices 12(1)-12(n) using other methods or techniques. Communication network 30 include local area networks (LAN), wide area network (WAN), 3G technologies, GPRS or EDGE technologies, although the communication network 30 can include other types and numbers of networks and other network topologies.

The emulation manager computing device 14 emulates mobile computing devices within a network environment 10 as illustrated and described with the examples herein, although emulation manager computing device 14 may perform other types and numbers of functions and in other types of networks. As illustrated in more specifically in FIG. 2, the emulation manager computing device 14 includes at least one processor 18, memory 20, input device 22 and display device 23, and input/output (I/O) system 24 which are coupled together by bus 26, although emulation manager computing device 14 may comprise other types and numbers of elements in other configurations.

Processor(s) 18 may execute one or more computer-executable instructions stored in the memory 20 for the methods illustrated and described with reference to the examples herein, although the processor(s) can execute other types and numbers of instructions and perform other types and numbers of operations. The processor(s) 18 may comprise one or more central processing units (“CPUs”) or general purpose processors with one or more processing cores, such as Intel®, ARM®), and AMD® processor(s), although other types of processors, platforms or operating systems could be used.

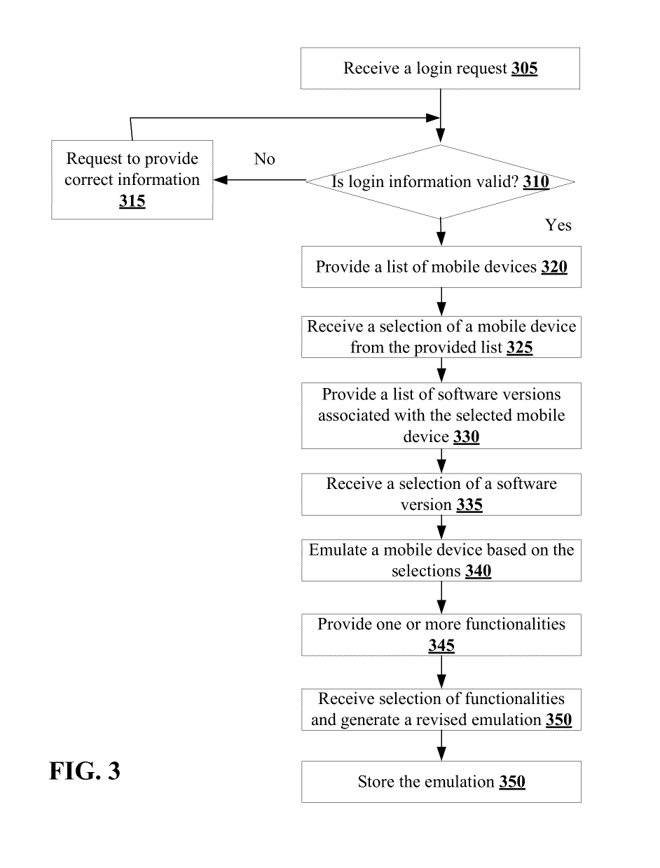

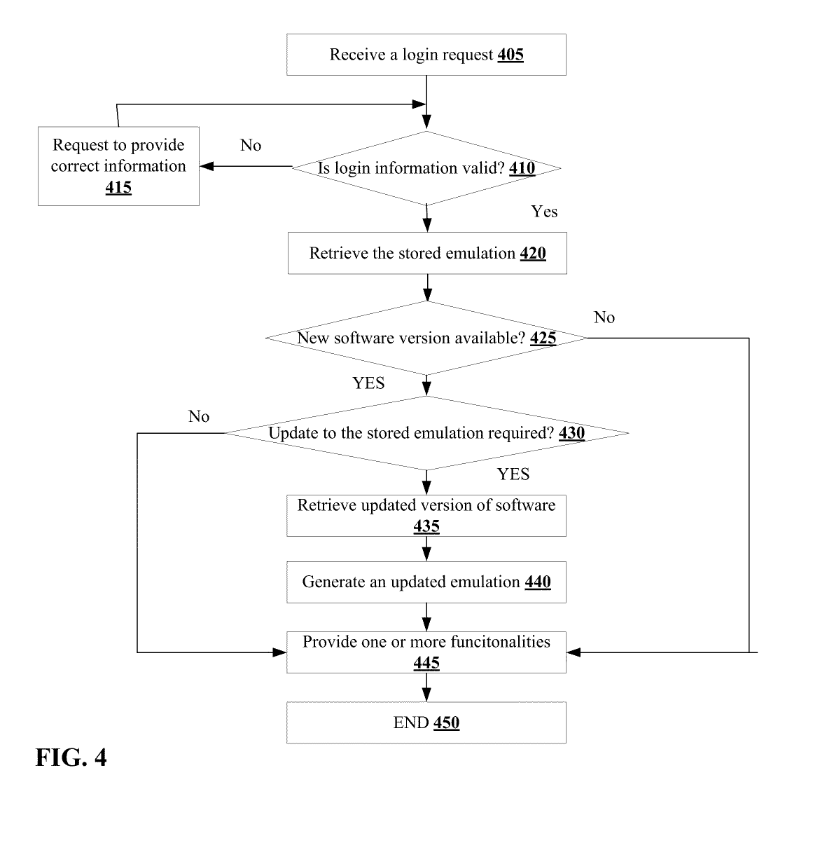

Memory 20 may comprise one or more tangible storage media, such as RAM, ROM, flash memory, CD-ROM, floppy disk, hard disk drive(s), solid state memory, DVD, or any other memory storage types or devices, including combinations thereof, which are known to those of ordinary skill in the art. Memory 20 may store one or more programmed instructions of this technology as illustrated and described with reference to the examples herein that may be executed by the one or more processor(s) 18. By way of example only, the flow charts shown in FIGS. 3-4 are representative of programmed steps or actions of this technology that may be embodied or expressed as one or more non-transitory computer or machine readable having stored instructions stored in memory 20 that may be executed by the processor(s) 18, although other types and numbers of programmed instructions and/or other data may be stored.

Input device 22 enables a user, such as an administrator, to interact with the emulation manager computing device 14, such as to input and/or view data and/or to configure, program and/or operate it by way of example only. By way of example only, input device 22 may include one or more of a touch screen, keyboard and/or a computer mouse.

The display device 23 enables a user, such as an administrator, to interact with the emulation manager computing device 14, such as to view and/or input information and/or to configure, program and/or operate it by way of example only. By way of example only, the display device 23 may include one or more of a CRT, LED monitor, LCD monitor, or touch screen display technology although other types and numbers of display devices could be used.

The I/O system 24 in the emulation manager computing device 14 is used to operatively couple and communicate between the emulation manager computing device 14 and the plurality of user computing devices 12(1)-12(n) and which are all coupled together by communication network 30. In this example, the bus 26 is a hyper-transport bus in this example, although other bus types and links may be used, such as PCI.

Each of the plurality of user computing devices 12(1)-12(n) may comprise one or more of the same or different types and/or versions of computing devices, such as smartphones, electronic book readers, tablet computers, and video game consoles by way of example only. Additionally, each of the plurality of user computing devices 12(1)-12(n) includes a central processing unit (CPU) or processor, a memory, an interface device, and an I/O system, which are coupled together by a bus or other link, although other numbers and types of network devices could be used. The plurality of user computing devices 12(1)-12(n) communicate with the emulation manager computing device 14 for requesting to emulate a computing device such as a mobile computing device, automobile, television or other types of electrical appliances, although the plurality of user computing devices 12(1)-12(n) can interact with the emulation manager computing device 14 by other techniques. The plurality of user computing devices 12(1)-12(n) may run interface application(s), such as a Web browser by way of example only that may provide an interface to make requests for and receive content and/or communicate with web applications stored on the emulation manager computing device 14 via the communication network 30. In this example, users, application developers or other types of users can use the plurality of user computing devices 12(1)-12(n) to request for emulating computing devices.

Although an exemplary network environment 10 with the plurality of user computing devices 12(1)-12(n) and emulation manager computing device 14 are described and illustrated herein, other types and numbers of systems, devices in other topologies can be used. It is to be understood that the systems of the examples described herein are for exemplary purposes, as many variations of the specific hardware and software used to implement the examples are possible, as will be appreciated by those skilled in the relevant art(s).

Furthermore, each of the systems of the examples may be conveniently implemented using one or more general purpose computer systems, microprocessors, digital signal processors, and micro-controllers, programmed according to the teachings of the examples, as described and illustrated herein, and as will be appreciated by those of ordinary skill in the art.

The examples may also be embodied as a non-transitory computer readable medium having instructions stored thereon for one or more aspects of the present technology as described and illustrated by way of the examples herein, as described herein, which when executed by a processor, cause the processor to carry out the steps necessary to implement the methods of the examples, as described and illustrated herein.

An exemplary method for emulating computing devices will now be described with reference to FIGS. 1-4.

In step 305, the emulation manager computing device 14 receives a request to login to a webpage for purpose of emulating a selected mobile device from one of a plurality of user computing devices 12(1)-12(n), although the emulation manager computing device 14 can receive other types of requests from other devices. Alternatively, the emulation manager computing device 14 can receive a request to emulate automobile, television or other types of electrical appliances from one of the plurality of user computing devices 12(1)-12(n). In this example, the emulation manager computing device receives a username and password in the login request, although the emulation manager computing device 14 can receive other types or amounts of information from the requesting one of the plurality of user computing devices 12(1)-12(n). By way of example only, the emulation manager computing device 14 receives the login request via a web application such as a web browser executing on the requesting one of a plurality of plurality of user computing devices 12(1)-12(n), although the emulation manager computing device can receive the request using other techniques. Alternatively in another example, the emulation manager computing device 14 can receive user credentials in form of application programming interfaces (API's), although the emulation manager computing device 14 can receive other types or amounts of information from the one of the plurality of user computing devices 12(1)-12(n).

In step 310, the emulation manager computing device 14 determines if the received login information is valid by comparing the received username and password with the information stored within the memory 20. In this example, the emulation manger computing device 14 determines the login information is valid when the username and password received from the requesting one of the plurality of user computing devices 12(1)-12(n) exactly matches with the corresponding username and password stored within the memory 20. The emulation manager computing device 14 determines that the received login information is not valid when either the username or password does not exactly match with the stored username and password or when the received username and password is not present within the memory 20.

Accordingly in this example, if the emulation manager computing device 14 determines that the received login information is not valid, then the No branch is taken to step 315 where the emulation manager computing device 14 may request the requesting one of the plurality of user computing devices 12(1)-12(n) to enter the correct username and password or register a new user. Alternatively, the emulation manager computing device 14 may also end this method based on other criteria, such as receiving incorrect login information above a stored threshold number of attempts.

If back in step 310 the emulation manager computing device 14 determines that the received login information is valid, the Yes branch is taken to step 320. In step 320, the emulation manager computing device 14 provides a list of mobile devices responsive to the request from the requesting one of a plurality of user computing devices 12(1)-12(n) which can be emulated by the emulation manager computing device 14, although the emulation manager computing device 14 can provide a list of other types of electrical appliances or automobiles. By way of example only, the emulation manager computing device 14 may provide a list of different mobile devices or different versions of a mobile device via a drop down menu option and a radio buttons on a webpage, although the emulation manager computing device 14 can provide the list using other techniques. By way of example only, the type of mobile devices may include mobile device from manufacturers such as Apple®, Samsung®, Blackberry ®, Motorola®, or Nokia®, although other types of mobile devices well known to a person having ordinary skill in the art can be used.

In step 325, the emulation manager computing device 14 receives a selection of one of the mobile device from the provided list of mobile devices from the requesting one of a plurality of user computing devices 12(1)-12(n), although the emulation manager computing device 14 can receive other types or amounts of selection from the other devices. By way of example only, the user using the requesting one of the plurality of user computing devices 12(1)-12(n) can select one of the mobile device from the provided list and can click a submit button for the emulation manager computing device 14 to receive the selection.

In step 330, the emulation manager computing device 14 provides a list of multiple of software versions available for the selected mobile device. Similar to providing the list of mobile devices, the emulation manager computing device 14 provides the list of software versions available for the selected mobile device via a drop down menu option and a radio buttons on a webpage, although the emulation manager computing device 14 can provide the list using other techniques. By way of example only, if the emulation manager computing device 14 receives a selection of a mobile device manufactured by Apple®, then the list of software versions provided by the emulation manager computing device 14 can be iOS® versions 5.0-7.2.

In step 335, the emulation manager computing device 14 receives a selection of one of the software version from the provided list similar to the technique illustrated in step 325. By way of example only, the user using the requesting one of the plurality of user computing devices 12(1)-12(n) can select one of the mobile device from the provided list and can click a submit button for the emulation manager computing device 14 to receive the selection.

In step 340, the emulation manager computing device 14 generates an emulation of the selected mobile device embedded with the selected software and provides it to the requesting one of the plurality of user computing devices 12(1)-12(n). By way of example only, the emulation manager computing device 14 generates an emulation of the selected mobile device embedded with the selected software version using software developer kit and other emulation provided by Google® and Apple®, although the emulation manager computing device 14 can use other techniques to generate the emulation. In this example, the emulation manager computing device 14 provides the generating emulation of the mobile device to the requesting one of the plurality of user computing devices 12(1)-12(n) via a web interface of the application executing on the requesting one of the plurality of user computing devices 12(1)-12(n), although other techniques could be used to provide the emulation. By providing the emulation via a web interface, the emulation manager computing device 14 does not require the requesting one of the plurality of user computing devices 12(1)-12(n) to download or install any additional software to receive the generated emulation. In this example, generating an emulation relates to creating a three dimensional interface of the selected mobile device and the selected software version embedded within the selected mobile device, although other types of interfaces, such as a two dimensional interface could be used. By generating an emulation and providing it to the requesting one of the plurality of user computing devices 12(1)-12(n), the technology provides benefits such as allowing the useruser using the requesting one of the plurality of user computing devices 12(1)-12(n) to use and explore the mobile device without having to actually visit a physical store or possessing a physical mobile device.

Next in step 345, the emulation manager computing device 14 provides one or more functionalities to the requesting one of the plurality of user computing devices 12(1)-12(n). By way of example only, the one or more functionalities includes, zoom-in, zoom-out, navigating to the next screen within the emulated mobile device, selecting applications within the emulated mobile device, although the one or more functionalities other types or amounts of features.

In step 350, the emulation manager computing device 14 receives a selection of the provided one or more functionalities from the requesting one of the plurality of user computing devices 12(1)-12(n). Based on the received selection of the one or more functionalities, the emulation manager computing device 14 in real-time generates a revised emulation of the mobile device and provides it to the requesting one of the plurality of user computing devices 12(1)-12(n). By way of example only, if the emulation manager computing device 14 receives a selection to open a particular application within the emulated mobile device, the emulation manager computing device 14 generates and provides a revised emulation of the mobile device which includes the selected application being open. Again by providing the revised emulation in real-time based on the received selections, the technology provides benefits such as allowing the user using the requesting one of the plurality of user computing devices 12(1)-12(n) to use and explore the mobile device without having to actually visit the physical store or possessing a physical mobile device.

In step 355, the emulation manager computing device 14 stores the generated emulation of the mobile device embedded with the selected software version. Additionally, while storing the generated emulation, the emulation manager computing device 14 stores the most recent revision of the emulation of the mobile device so that the user using the requesting one of the plurality of user computing devices 12(1)-12(n) can interact with the revised emulation from a point at which the user was previously interacting. By way of example only, if the user had selected to open an application in the provided emulation and then closes the generated emulation, the emulation manager computing device 14 stores the emulation with the application being open so that when the user returns to interact with the generated emulation, the user can directly start with the application being open. In this example, the emulation manager computing device 14 stores the generated emulation within the memory 20 and tags the stored emulation to the received login information from the requesting one of the plurality of user computing devices 12(1)-12(n), although the emulation manager computing device 14 can store the emulation at other locations using other techniques.

An example of a method for using a stored emulation will now be illustrated with reference to FIG. 4. In step 405, the emulation manager computing device 14 receives a request to login to a webpage for purpose of obtaining a stored emulating a mobile device from one of a plurality of user computing devices 12(1)-12(n), although the emulation manager computing device 14 can receive other types of requests from other devices. As previously illustrated in step 305, the emulation manager computing device 14 receives a username and password in the login request, although the emulation manager computing device 14 can receive other types or amounts of information from the requesting one of the plurality of user computing devices 12(1)-12(n). By way of example only, the emulation manager computing device 14 receives the login request via a web application such as a web browser executing on the requesting one of a plurality of user computing devices 12(1)-12(n), although the emulation manager computing device can receive the request using other techniques.

In step 410 similar to step 310, the emulation manager computing device 14 determines if the received login information is valid by comparing the received username and password with the information stored within the memory 20. In this example, the emulation manger computing device 14 determines that the login information is valid when the username and password received from the requesting one of the plurality of user computing devices 12(1)-12(n) exactly matches with the corresponding username and password stored within the memory 20. The emulation manager computing device 14 determines that the received login information is not valid when either the username or password does not exactly match with the stored username and password or when the received username and password is not present within the memory 20.

Accordingly in this example, if the emulation manager computing device 14 determines that the received login information is not valid, then the No branch is taken to step 415 where the emulation manager computing device 14 requests the requesting one of the plurality of user computing devices 12(1)-12(n) to enter the correct username and password or register a new user. Alternatively, the emulation manager computing device 14 may also end this method based on other criteria, such as receiving incorrect login information above a stored threshold number of attempts.

If back in step 410 the emulation manager computing device 14 determines that the received login information is valid, then the Yes branch is taken to step 420. In step 420, the emulation manager computing device 14 retrieves the stored emulation associated with the login information from memory 20, although the emulation manager computing device 14 can receive the stored emulation from other memory locations. As previously illustrated in step 355, the stored emulation retrieved by emulation manager computing device 14 is the most recent revision of the emulation of the mobile device so that the user using the requesting one of the plurality of user computing devices 12(1)-12(n) can interact with the revised emulation from a point at which the user was previously interacting. By way of example only, if the user had selected to open an application in the provided emulation and then closes the generated emulation, the stored emulation retrieved by emulation manager computing device 14 includes the emulation in which the previously selected application being open.

In step 425, the emulation manager computing device 14 determines if there is an updated or new version of the software available compared to the one embedded within the emulated mobile device. By way of example only, the emulation manager computing device 14 frequently updates a database stored within the memory 20 with the most recent, updated or newer versions of the software available for the mobile devices by monitoring the releases from the mobile manufactures, although the emulation manager computing device 14 can use other techniques to determine if there is an updated or new software version available for the emulated mobile device. Optionally, the emulation manager computing device 14 can also determine if there is a new model or version of the emulated mobile device available using technique illustrated above. Accordingly, if the emulation manager computing device 14 determines that there is an updated or new version of the software is not available, then the No branch is taken step 445 which will be further illustrated below. However, if the emulation manager computing device 14 determines that there is an updated or new version of the software that is available, then the Yes branch is taken step 430.

In step 430, the emulation manager computing device 14 determines if the software embedded within the emulated mobile device is required to be updated. In this example, the emulation manager computing device provides a notification to the requesting one of the plurality of user computing devices 12(1)-12(n) indicating the availability of the updated or new software version. Upon providing the notification, the emulation manager computing device 14 determines if the software embedded within the emulated mobile device is required to be updated by requesting the user using the requesting one of the plurality of user computing devices 12(1)-12(n) to select either an option of requiring an update or not requiring an update. For purpose of further illustration, if the emulation manager computing device 14 receives a selection of update is required from the requesting one of the plurality of user computing device 12(1)-12(n), then the emulation manager computing device 14 determines that the software embedded within the emulated mobile device is required to be updated. However, if the if the emulation manager computing device 14 receives a selection of update is not required from the requesting one of the plurality of user computing device 12(1)-12(n), then the emulation manager computing device 14 determines that the software embedded within the emulated mobile device is not required to be updated. Accordingly, if the emulation manger computing device 14 determines that the update is not required, then the No branch is taken to step 445.

If in step 430, the emulation manager computing device 14 determines that the updated is required, then the Yes branch is taken to step 435. In step 435, the emulation manager computing device 14 retrieves the updated or new version of the software from the memory 20, although the emulation manager computing device 14 can retrieve the software version from other memory locations.

In step 440, the emulation manager computing device 14 generates and provides an updated emulation by embedding the retrieved new or updated version of the software within the selected mobile device using technique illustrated in step 340.

Next in step 445, the emulation manager computing device 14 provides one or more functionalities to the requesting one of the plurality of user computing devices 12(1)-12(n) to interact with the updated emulation using technique illustrated in steps 345 and 350 and the exemplary method ends in step 450.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for emulating a mobile computing device, the method comprising:
obtaining, by an emulation manager computing device, a stored emulation of a selected one of a plurality of type of mobile computing devices embedded with a one of a plurality of software versions;
determining, by an emulation manager computing device, when an updated version of the embedded one of the plurality of software versions is available for the stored emulation;
generating, by the emulation manager computing device, an updated emulation from the stored emulation, wherein the updated emulation comprises the selected one of the plurality of types of mobile computing devices embedded with the updated version of the embedded one of the plurality of software versions; and
providing, by the emulation manager computing device, the generated updated emulation without requiring a requesting user computing device to download or install additional software.

2. The method as set forth in claim 1 wherein the providing further comprises:
providing, by the emulation manager computing device, one or more functionalities to use with the provided emulation of the selected one of the plurality of types of mobile computing devices embedded with the selected one of the plurality software versions;
receiving, by the emulation manager computing device, one or more selections of the provided one or more functionalities; and
revising, by the emulation manager computing device, the generated emulation by applying the received one or more selections of the provided one or more functionalities to the generated emulation.

3. The method as set forth in claim 2 further comprising storing, by the emulation manager computing device, the revised emulation of the selected one of the plurality of types of mobile computing devices embedded with the selected one of the plurality software versions.

4. The method as set forth in claim 1 wherein the determining further comprises providing, by the emulation manager computing device, a notification indicating the availability of the updated version the embedded one of the plurality of software versions when the updated version is determined to be available.

5. The method as set forth in claim 4 further comprising:
determining, by the emulation manager computing device, whether the updated version is required to be obtained based on an input received responsive to the provided notification;
obtaining, by the emulation manager computing device, the updated version of the selected one of the plurality of software versions when the updated version is determined to be required; and
upgrading, by the emulation manager computing device, the selected one of the plurality of types of mobile computing devices in the stored emulation with the obtained updated version.

6. The method as set forth in claim 1 further comprising:
receiving, by the emulation manager computing device, a selection of one of a plurality of types of mobile computing devices from a dynamic library;
receiving, by the emulation manager computing device, a selection of one of a plurality of software versions associated with the selected one of the plurality of types of mobile computing devices;
generating, by the emulation manager computing device, an emulation of the selected one of the plurality of types of mobile computing devices embedded with the selected one of the plurality software versions;
providing, by the emulation manager computing device, the generated emulation of the selected one of the plurality of types of mobile computing devices embedded with the selected one of the plurality software versions without any additional download or installation; and
storing, by the emulation manager computing device, the provided emulation.

7. A non-transitory computer readable medium having stored thereon instructions for emulating a mobile computing device comprising machine executable code which when executed by at least one processor, causes the processor to perform steps comprising:
obtaining a stored emulation of a selected one of a plurality of type of mobile computing devices embedded with a one of a plurality of software versions;
determining when an updated version of the embedded one of the plurality of software versions is available for the stored emulation;
generating an updated emulation from the stored emulation, wherein the updated emulation comprises the selected one of the plurality of types of mobile computing devices embedded with the updated version of the embedded one of the plurality of software versions; and
providing the generated updated emulation without requiring a requesting user computing device to download or install additional software.

8. The medium as set forth in claim 7 wherein the providing further comprises:
providing one or more functionalities to use with the provided emulation of the selected one of the plurality of types of mobile computing devices embedded with the selected one of the plurality software versions;
receiving one or more selections of the provided one or more functionalities; and
revising the generated emulation by applying the received one or more selections of the provided one or more functionalities to the generated emulation.

9. The medium as set forth in claim 8 further comprising storing the revised emulation of the selected one of the plurality of types of mobile computing devices embedded with the selected one of the plurality software versions.

10. The medium as set forth in claim 7 wherein the determining further comprises providing a notification indicating the availability of the updated version the embedded one of the plurality of software versions when the updated version is determined to be available.

11. The medium as set forth in claim 10 further comprising:
determining whether the updated version is required to be obtained based on an input received responsive to the provided notification;
obtaining the updated version of the selected one of the plurality of software versions when the updated version is determined to be required; and
upgrading the selected one of the plurality of types of mobile computing devices in the stored emulation with the obtained updated version.

12. The medium as set forth in claim 7 further comprising:
receiving a selection of one of a plurality of types of mobile computing devices from a dynamic library;
receiving a selection of one of a plurality of software versions associated with the selected one of the plurality of types of mobile computing devices;
generating an emulation of the selected one of the plurality of types of mobile computing devices embedded with the selected one of the plurality software versions;
providing the generated emulation of the selected one of the plurality of types of mobile computing devices embedded with the selected one of the plurality software versions without any additional download or installation; and
storing the provided emulation.

13. An emulation manager computing device comprising:
a processor;
a memory, wherein the memory coupled to the processor which are configured to execute programmed instructions stored in the memory comprising:
obtaining a stored emulation of a selected one of a plurality of type of mobile computing devices embedded with a one of a plurality of software versions;
determining when an updated version of the embedded one of the plurality of software versions is available for the stored emulation;
generating an updated emulation from the stored emulation, wherein the updated emulation comprises the selected one of the plurality of types of mobile computing devices embedded with the updated version of the embedded one of the plurality of software versions; and
providing the generated updated emulation without requiring a requesting user computing device to download or install additional software.

14. The device as set forth in claim 13 wherein the processor is further configured to execute programmed instructions stored in the memory for the providing further comprises:
providing one or more functionalities to use with the provided emulation of the selected one of the plurality of types of mobile computing devices embedded with the selected one of the plurality software versions;
receiving one or more selections of the provided one or more functionalities; and
revising the generated emulation by applying the received one or more selections of the provided one or more functionalities to the generated emulation.

15. The device as set forth in claim 14 wherein the processor is further configured to execute programmed instructions stored in the memory further comprising storing the revised emulation of the selected one of the plurality of types of mobile computing devices embedded with the selected one of the plurality software versions.

16. The device as set forth in claim 13 wherein the processor is further configured to execute programmed instructions stored in the memory for the determining further comprises providing a notification indicating the availability of the updated version the embedded one of the plurality of software versions when the updated version is determined to be available.

17. The device as set forth in claim 16 wherein the processor is further configured to execute programmed instructions stored in the memory further comprising:
determining whether the updated version is required to be obtained based on an input received responsive to the provided notification;
obtaining the updated version of the selected one of the plurality of software versions when the updated version is determined to be required; and
upgrading the selected one of the plurality of types of mobile computing devices in the stored emulation with the obtained updated version.

18. The device as set forth in claim 13 wherein the processor is further configured to execute programmed instructions stored in the memory further comprising:
receiving a selection of one of a plurality of types of mobile computing devices from a dynamic library;
receiving a selection of one of a plurality of software versions associated with the selected one of the plurality of types of mobile computing devices;
generating an emulation of the selected one of the plurality of types of mobile computing devices embedded with the selected one of the plurality software versions;
providing the generated emulation of the selected one of the plurality of types of mobile computing devices embedded with the selected one of the plurality software versions without any additional download or installation; and
storing the provided emulation.
